(19) United States
(12) Patent Application Publication
(10) Pub. No.: US 2016/0165211 A1
(43) Pub. Date: Jun. 9, 2016

(54) AUTOMOTIVE IMAGING SYSTEM

(71) Applicant: Board of Trustees of the University of Alabama, Tuscaloosa, AL (US)

(72) Inventor: Bharat Balasubramanian, Tuscaloosa, AL (US)

(21) Appl. No.: 14/944,127

(22) Filed: Nov. 17, 2015

Related U.S. Application Data
(60) Provisional application No. 62/088,933, filed on Dec. 8, 2014.

(51) Int. Cl. H04N 13/02; B60R 11/04; B60R 1/00; H04N 5/232

(52) U.S. Cl. CPC H04N 13/0242; H04N 5/23238; B60R 11/04; B60R 1/00; H04N 2013/0088

(57) ABSTRACT

Various implementations include an automotive imaging system that includes at least three cameras disposed on a vehicle and an electronic control unit (ECU) in electronic communication with the cameras. The three cameras have overlapping fields of view, and a processor of the ECU may be configured for generating at least three stereoscopic images from images captured by each pair of cameras and blending these stereoscopic images into one high quality panoramic image. These images provide a wider field of coverage and improved images, which improves the ability of the safety and advanced driver assistance systems of the vehicle to detect and identify potential collision hazards and conduct situational analyses of the vehicle according to certain implementations.

### CROSS-REFERENCE TO RELATED APPLICATIONS

This application claims priority to U.S. Provisional Patent Application No. 62/088,933, filed Dec. 8, 2014, and entitled “AUTOMOTIVE IMAGING SYSTEM,” the entire disclosure of which is incorporated herein by reference.

### BACKGROUND

Known automotive camera systems may include a pair of fixed cameras (e.g., stereovision cameras) disposed adjacent the rear view mirror on the front windshield that has a combined field of view extending in front of the vehicle of about 40° to about 60°. An exemplary set up is shown in FIG. 1. The images from this camera pair may be used to generate three-dimensional, or stereoscopic, images of objects within the field of views of the cameras. These stereoscopic images are used for object detection and collision avoidance by safety and advanced driver assistance systems of the vehicle. For example, the vehicle may use the images for detecting objects that are in the path of the vehicle and identifying the objects (e.g., a person, animal, or another car). In addition, the images may be used for situational analysis by the safety and advanced driver assistance systems (e.g., how close are other vehicles or static objects, collision risk). When the safety and advanced driver assistance systems detect an object or situation that poses a safety risk for the vehicle, the safety and advanced driver assistance systems may intervene to protect the vehicle through passive or active interventions. For example, passive interventions may include sounding an alarm, illuminating a light or display, or providing haptic (e.g., vibrational) feedback to the driver. Active interventions may include adjusting the angle or torque of the steering wheel, applying the brakes, reducing the throttle, or other interventions that actively alter the course or speed of the vehicle.

However, this stereo camera system has some drawbacks that may affect the reliability of the safety and advanced driver assistance systems. In particular, the combined field of view of the cameras may not wide enough to reliably capture all images that may be in front of the vehicle without giving up resolution or capturing distorted images. In addition, if one of the two cameras malfunctions during a critical maneuver, or driving event, the camera system would lose its ability to generate a stereoscopic image, which could cause the safety and advanced driver assistance systems to fail. Furthermore, images captured by cameras that have low resolution decrease the ability of the safety and advanced driver assistance systems to detect and recognize objects that may pose collision or safety risks for the vehicle.

Accordingly, there is a need in the art for an improved automotive camera system.

### BRIEF SUMMARY

Various implementations include an automotive imaging system that includes at least three cameras disposed on a vehicle and an electronic control unit (ECU) in electronic communication with the cameras. The three cameras have overlapping fields of view, and a processor of the ECU may be configured for: (1) blending the images captured from the fields of view of the cameras to produce a single panoramic image, (2) generating and blending together at least three stereoscopic images from images captured by each pair of cameras, and (3) identifying at least one optimal camera setting for each of one or more cameras based on a plurality of images sequentially taken by the camera at different camera settings. Generating and blending stereoscopic images from images captured by each pair of cameras provides a high quality (or resolution) stereoscopic panoramic image. These images provide a wider field of coverage and improved images, which improves the ability of the safety and advanced driver assistance systems of the vehicle to detect and identify potential collision hazards and conduct situational analyses of the vehicle according to certain implementations.

In particular, various implementations include an automotive imaging system that includes at least three cameras disposed on a vehicle and an electronic control unit (ECU) in electronic communication with the cameras. The three cameras include a first camera having a first field of view, a second camera having a second field of view, and a third camera having a third field of view. The fields of view are generally directed toward a front portion of a vehicle on which the three cameras are mounted. The ECU includes a processor and a memory, and the processor is configured for: (1) receiving images captured in the first, second, and third fields of view by the cameras and (2) blending the images together to produce a single panoramic image. In addition, in certain implementations, the processor may be configured for communicating the blended image to one or more safety and advanced driver assistance systems of the vehicle and/or storing the blended image in the memory.

In some implementations, the fields of view may be between about 40° and about 60°, and a total field of view of the blended single image is about 120° to about 180°. In addition, the first camera may be disposed on a windshield adjacent a left A-pillar of the vehicle, the second camera may be disposed on the windshield adjacent a center of the vehicle (e.g., adjacent the rear view mirror), and the third camera may be disposed on the windshield adjacent a right A-pillar of the vehicle. In certain implementations, the cameras are spaced about 35 to about 60 centimeters apart.

The images captured by each pair of cameras may be used to generate a stereoscopic image. For example, the images captured by the first and second cameras are used to generate a first stereoscopic image, the images captured by the second and third cameras are used to generate a second stereoscopic image, and the images captured by the first and third cameras are used to generate a third stereoscopic image. The three stereoscopic images are then blended together to produce the single panoramic, stereoscopic image of the area within the combined field of view of the cameras.

Furthermore, in certain implementations, one or more camera settings of one or more of the cameras may be variable. Camera settings may include the aperture size, shutter speed, ISO range, etc. In such implementations, the processor may be configured for periodically identifying one or more optimal camera settings for the camera and setting one or more operational camera settings for the camera to the optimal camera settings for the camera until the identified optimal camera settings change. For example, the processor may be configured for identifying an optimal camera setting for a particular camera based on a set of three or more images taken at various camera settings (e.g., a first aperture setting, a second aperture setting, and a third aperture setting) by the camera. In addition, the processor may be configured for identifying the optimal camera setting for the particular camera periodically, such as every about 10 to about 60 seconds, for example, and the processor may identify the optimal camera setting for each camera at a separate time than the other cameras. Such an implementation prevents more than one camera from not being used for capturing images for the safety and advanced driver assistance systems at a given time.

Additional advantages are set forth in part in the description that follows and the figures, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying figures, which are incorporated in and constitute a part of this specification, illustrate several aspects of the invention and together with the description serve to explain the principles of the invention.

FIG. 1 illustrates a known camera system.

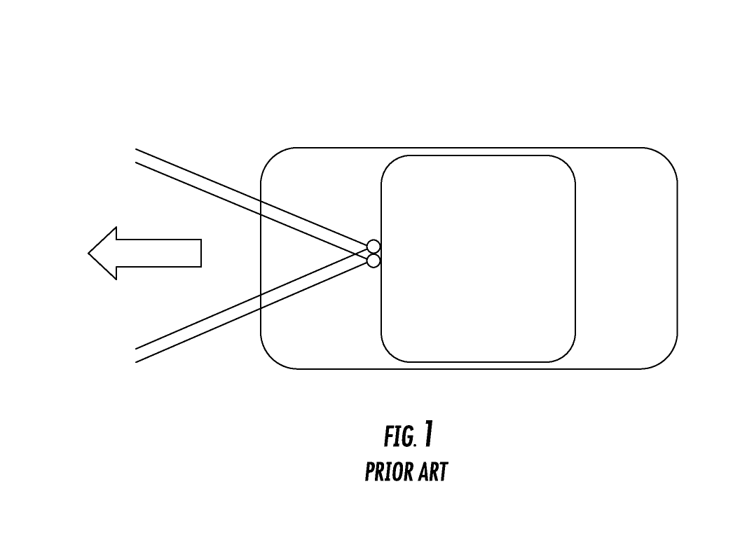

FIG. 2 illustrates a schematic of a camera system according to one implementation.

FIG. 3 illustrates a schematic of a camera system according to another implementation.

FIG. 4 illustrates a schematic of a computing device according to one implementation.

FIG. 5 is a flow chart illustrating a method of processing images from three or more cameras mounted on a vehicle according to one implementation.

### DETAILED DESCRIPTION

Various implementations include an automotive imaging system that includes at least three cameras disposed on a vehicle and an electronic control unit (ECU) in electronic communication with the cameras. The three cameras have overlapping fields of view, and a processor of the ECU may be configured for: (1) blending the images captured from the fields of view of the cameras to produce a single panoramic image, (2) generating and blending together at least three stereoscopic images from images captured by each pair of cameras, and (3) identifying at least one optimal camera setting for each of one or more cameras based on a plurality of images sequentially taken by the camera at different camera settings. Generating and blending stereoscopic images from images captured by each pair of cameras provides a high quality (or resolution) stereoscopic panoramic image. These images provide a wider field of coverage and improved images, which improves the ability of the safety and advanced driver assistance systems of the vehicle to detect and identify potential collision hazards and conduct situational analyses of the vehicle according to certain implementations.

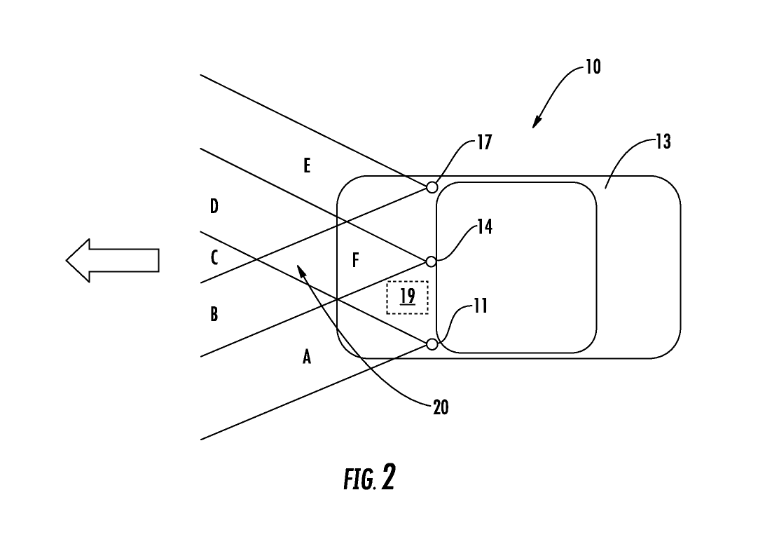

FIG. 2 illustrates an exemplary camera system according to one implementation. In particular, the camera system 10 includes a first camera 11 disposed on a windshield adjacent a left front A-pillar of the vehicle 13, a second camera 14 disposed on the windshield adjacent a rear view mirror of the vehicle 13, a third camera 17 disposed on the windshield adjacent a right front A-pillar of the vehicle 13, and an electronic control unit 19 disposed within the vehicle 13 that is in electronic communication with the cameras 11, 14, 17 and the safety and advanced driver assistance systems (not shown). Each camera 11, 14, 17 has a field of view A, F, E, respectively, that is fixed and may be between about 40° and about 60°. Portions of the fields of view A, F, E, of the cameras overlap, such that the field of view A of camera 11 overlaps with the field of view F of camera 14 to the left of a front center 20 of the vehicle 13 in area B, the field of view F of camera 14 overlaps with the field of view E of camera 17 to the right of the front center 20 of the vehicle 13 in area D, and the fields of view of the first and third cameras 11, 17 overlap in front of the front center 20 of the vehicle 13 in area C. Thus, the combined field of view of the cameras 11, 14, 17, which covers the areas A through F, may be between about 120° to about 180°. As shown in FIG. 2, the combined field of view of the three cameras 11, 14, 17 extends in front of the vehicle 13.

The resolution of a 3D, stereoscopic image generated from images captured by each pair of cameras is proportional to the spacing of each pair of cameras. For example, more lateral shift of an object with the fields of view of the cameras is detected by a pair of cameras that are spaced closer together. For a typical vehicle, a line extending from an inner edge of each front A-pillar through a central point of the windshield adjacent the rear-view mirror is about 80 to about 120 centimeters long. Thus, the first 11 and third cameras 17 may be spaced about 70 to about 120 cm apart from each other and about 35 to about 60 cm apart from the second camera 14. In contrast, prior camera systems have cameras that are spaced apart by about 15 to 25 centimeters. By spacing apart the cameras 11, 14, 17 as shown in FIG. 2, the stereoscopic images captured by each pair of cameras have improved resolution over images captured by prior camera systems. In addition, an object in the field of view of one of the first or third cameras 11, 17, respectively, may be detectable by the cameras 11, 17 before the object is within the field of view of and detectable by the driver or second camera 14, which improves the field of coverage of the camera system 10. This situation may arise when the vehicle is turning a corner or coming around a sharp curve, for example. Thus, by blending the three 3D, stereoscopic images into one panoramic image, the quality of resolution of the panoramic image is improved, the field of coverage is increased, and the ability of the vehicle safety and advanced driver assistance systems to conduct object detection and perform situational analyses is improved.

The cameras 11, 14, 17 may be charged coupling device (CCD) cameras, complementary metal-oxide semiconductor (CMOS) cameras, or another suitable type of digital camera or image capturing device. In addition, the second camera 14 may be a fixed position, variable setting camera, and the first 11 and third cameras 17 may be fixed position, fixed setting cameras. Camera settings that may be variable include the aperture size, shutter speed, and/or ISO range, for example. For example, one or more of the cameras 11, 14, 17 may be configured for capturing around 10 to around 20 frames per second. Other implementations may include cameras configured for capturing more frames per second. In alternative implementations, all three cameras may be fixed position, fixed setting cameras or fixed position, variable setting cameras. And, in other implementations, the cameras may be movable. Furthermore, in some implementations, the camera settings, such as, for example, the shutter speed and ISO would be increased as the speed of the vehicle increases.

The ECU 19 is disposed within the vehicle and is in electronic communication with the cameras 11, 14, 17. In addition, the ECU 19 may be further configured for electronically communicating with one or more safety and advanced driver assistance systems of the vehicle. The processor of the ECU 19 is configured for processing the images from the cameras 11, 14, 17 to provide various types of images. For example, the processor may be configured to generate a first stereoscopic image from images captured by the first 11 and second cameras 14, a second stereoscopic image from images captured by the second 14 and third cameras 17, and a third stereoscopic image from images captured by the first 11 and third cameras 17. The processor then blends these stereoscopic images together to generate a single panoramic image of high resolution and improved field of coverage.

In addition, in certain implementations in which at least one camera 11, 14, 17 is a variable setting camera, the processor of the ECU 19 may be configured for identifying one or more optimal camera settings for the variable setting camera periodically. The camera settings may include the aperture, shutter speed, ISO, and/or other camera settings that may be adjusted depending on ambient lighting or weather conditions. After the optimal camera settings are identified, operational camera settings are set to the optimal settings, and the camera uses the operational camera settings to capture images for use by the safety and advanced driver assistance systems until a new set of optimal camera settings are identified.

According to some implementations, the processor is configured for identifying the optimal camera settings for a particular camera by receiving a set of three or more images captured sequentially at different camera settings by the camera. For example, the different camera settings may include a first aperture setting for a first image of the set, a second aperture setting for a second image of the set, and a third aperture setting for a third image of the set. Special image quality analysis tools could be employed to identify the settings that correspond with the optimal image of the set of images. The setting(s) that corresponds with the optimal image of the set of images is identified as the optimal setting, and the processor sets an operational setting for the camera to the identified optimal setting. The optimal image may, for example, be the image that includes the most amount of objects detected. Additionally or alternatively, the optimal image may be the image that includes a level of color tone, brightness, and/or picture quality that falls within a preset range corresponding with what the human eye would expect to see when viewing the scene captured by the camera. In addition, in certain implementations, the processor may be configured for identifying the optimal camera setting for the particular camera periodically, such as every about 10 to about 60 seconds, for example. Furthermore, the optimal camera setting for each camera is identified one camera at a time (not simultaneously), according to one implementation. Such an implementation assures that only one camera is not being used for capturing images for the safety and advanced driver assistance systems at a given time.

In certain implementations, the processor includes field programmable gate arrays (FPGA) to receive images from the cameras, generate stereoscopic images from each pair of cameras, and blend the stereoscopic images into a single, high resolution panoramic image as described above. FPGAs provide a relatively fast processing speed, which is particularly useful in identifying potential collision or other safety risks. Other improvements that allow for faster processing of safety and advanced driver assistance systems may include parallel processing architecture, for example.

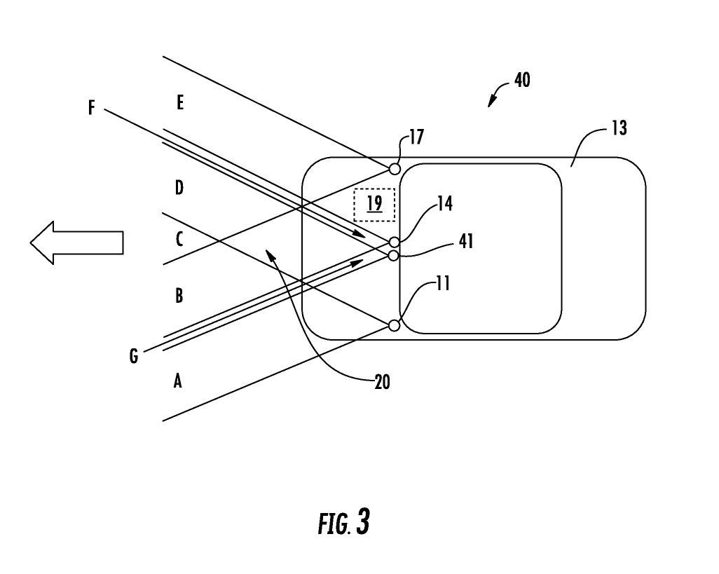

FIG. 3 illustrates an alternative implementation of a camera system 40 in which a fourth camera 41 is mounted laterally adjacent the second camera 14. The fourth camera 41 is spaced laterally apart from the second camera 14 by about 10 to about 25 centimeters. The field of view G of the fourth camera 41 may have a similar angle as the field of view F of the second camera 14, and the images detected by each pair of cameras 11, 14, 41, 17 may be used to generate six stereoscopic images. These stereoscopic images may then be blended together to generate a single panoramic image.

According to some implementations, by providing at least three cameras that are laterally spaced apart along the front of the vehicle, the other cameras may serve as backups for a failed camera during a critical maneuver or driving situation. The remaining cameras continue their task of receiving images, and the processor uses the images from the remaining cameras to generate a single stereoscopic image, which can be communicated to the safety and advanced driver assistance systems. The driver may be informed of the failed camera after the critical maneuver is completed or the situation has been resolved using the remaining cameras. Until the failed camera is replaced, the processor may communicate with the remaining cameras in a back up (or fail safe) mode.

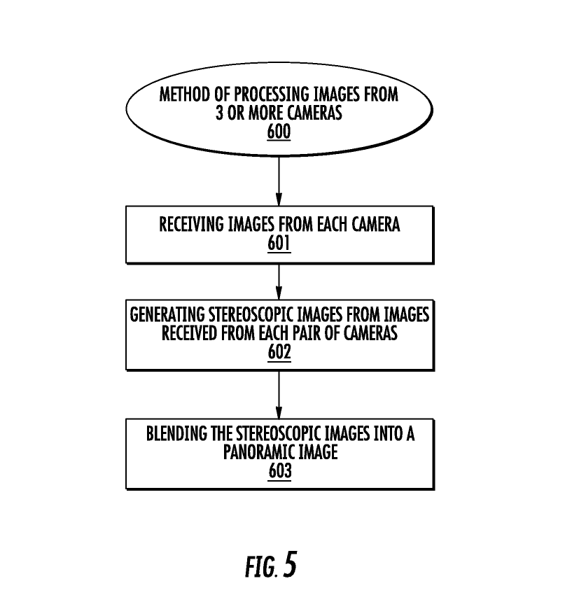

FIG. 5 illustrates a flow chart of a method 600 of processing images from three or more cameras according to various implementations. Beginning at step 601, images from three or more camera disposed on a front portion of a vehicle are received. In step 602, stereoscopic images are generated using the images from each pair of cameras. And, in step 603, the stereoscopic images are blended together to generate a single, panoramic image of the combined field of view of the cameras. For example, when the method of FIG. 5 is applied to the system shown in FIG. 2 according to one implementation, the images received in step 601 include images from cameras 11, 14, 17. The stereoscopic images generated in step 602 include a first stereoscopic image generated from the images captured by the first 11 and second cameras 14, a second stereoscopic image generated from the images captured by the second 14 and third cameras 17, and a third stereoscopic image generated from the images captured by the first 11 and third cameras 17. And, the blended image from step 603 includes the combined field of view of the cameras 11, 14, 17, which includes areas A through F in FIG. 2. As another example, when the method of FIG. 5 is applied to the system shown in FIG. 3 according to one implementation, the images received in step 601 include images from cameras 11, 14, 41, and 17. The stereoscopic images generated in step 602 include a first stereoscopic image generated from images captured by the first 11 and second cameras 14, a second stereoscopic image generated from the images captured by the second 14 and third cameras 17, a third stereoscopic image generated from the images captured by the first 11 and third cameras 17, a fourth stereoscopic image generated from the images captured by the first 11 and fourth cameras 41, a fifth stereoscopic image generated from the images captured by the second 14 and fourth cameras 41, and a sixth stereoscopic image generated from the images captured by the third 17 and fourth cameras 41. And, the blended image from step 603 includes the combined field of view of the cameras 11, 14, 17, 41, which includes areas A through G in FIG. 3.

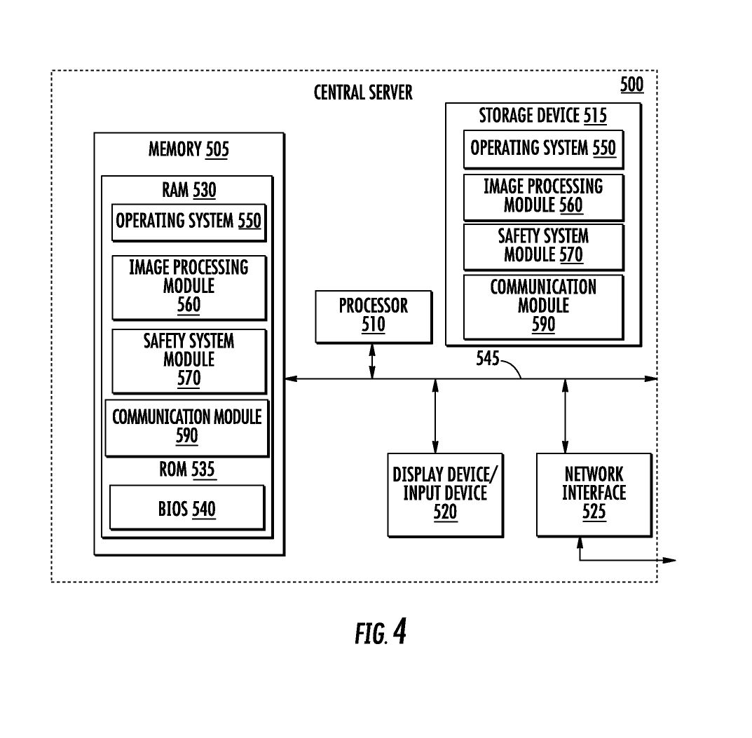

To process the images received from the cameras 11, 14, 17, 41, a computer system, such as the central server 500 shown in FIG. 4 may be used, according to one implementation. The server 500 executes various functions of the systems 10, 40 described above in relation to FIGS. 2 and 3. For example, the server 500 may be the ECU 19 described above, or a part thereof. As used herein, the designation “central” merely serves to describe the common functionality the server provides for multiple clients or other computing devices and does not require or infer any centralized positioning of the server relative to other computing devices. As may be understood from FIG. 4, in this implementation, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard, pointing device, or touch pad that is used in combination with a monitor. The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks. In addition, the server 500 may include a network interface 525 configured for communicating data with other computing devices.

A number of program modules may be stored by the various storage devices and within RAM 530. Such program modules may include an operating system 550 and a plurality of one or more modules, such as an image processing module 560 and a communication module 590. The modules 560, 590 may control certain aspects of the operation of the central server 500, with the assistance of the processor 510 and the operating system 550. For example, the modules 560, 590 may perform the functions described and illustrated by the figures and other materials disclosed herein.

The functions described herein and in the flowchart shown in FIG. 5 illustrate the architecture, functionality, and operation of possible implementations of systems, methods and computer program products according to various implementations of the present invention. Each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although multiple cameras have been mounted on vehicles such that their fields of view cover an area behind the vehicle, those systems are not generating stereoscopic images using this images captured by the cameras, and the spacing of the cameras does not provide the improved resolution provided by the camera systems described above. Thus, the safety and advanced driver assistance systems used in conjunction with various implementations of the claimed camera systems receives images with higher resolution and better quality, which improves the ability of the safety and advanced driver assistance systems to anticipate safety risks to the vehicle that are in front of the vehicle.

The systems and methods recited in the appended claims are not limited in scope by the specific systems and methods of using the same described herein, which are intended as illustrations of a few aspects of the claims. Any systems or methods that are functionally equivalent are intended to fall within the scope of the claims. Various modifications of the systems and methods in addition to those shown and described herein are intended to fall within the scope of the appended claims. Further, while only certain representative systems and method steps disclosed herein are specifically described, other combinations of the systems and method steps are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

Any combination of one or more computer readable medium(s) may be used to implement the systems and methods described hereinabove. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), such as Bluetooth or 802.11, or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. An automotive imaging system comprising:
at least three cameras comprising a first camera, a second camera, and a third camera, the first camera having a first field of view, the second camera having a second field of view, and the third camera having a third field of view, the fields of view being generally directed toward a front portion of a vehicle on which the three cameras are disposed, wherein the first camera is disposed adjacent a left, front portion of the vehicle, the second camera is disposed adjacent a central portion of the front of the vehicle, and the third camera is disposed adjacent a right, front portion of the vehicle, and wherein the second field of view overlaps a portion of each of the first field of view and the third field of view, and a portion of the first field of view overlaps a portion of the third field of view; and
an electronic control unit (ECU) in electronic communication with the cameras, the ECU comprising a processor and a memory, and the processor being configured for:
receiving images captured in the first, second, and third fields of view by the cameras;
generating a first stereoscopic image from the images captured by the first and second cameras, a second stereoscopic image from the images captured by the second and third cameras, and a third stereoscopic image from the images captured by the first and third cameras; and
blending the first, second, and third stereoscopic images to generate a single, panoramic image.

2. The automotive imaging system of claim 1, wherein the processor is further configured for communicating the blended image to a safety and advanced driver assistance system of the vehicle.

3. The automotive imaging system of claim 1, wherein the processor is further configured for storing the blended image in the memory.

4. The automotive imaging system of claim 1, wherein each of the first, second, and third fields of view is between about 40° and about 60°, and a total field of view of the blended single image is about 120° to about 180°.

5. The automotive imaging system of claim 4, wherein the first camera is disposed on a windshield adjacent a left A-pillar of the vehicle, the second camera is disposed on the windshield adjacent a rear view mirror of the vehicle, and the third camera is disposed on the windshield adjacent a right A-pillar of the vehicle.

6. The automotive imaging system of claim 5, wherein the second camera is spaced apart from the first camera and the third camera by about 35 to about 60 centimeters.

7. The automotive imaging system of claim 1, wherein the processor is further configured for generating one stereoscopic image from two of the three cameras in response to a third of the three cameras failing during vehicle operation.

8. The automotive imaging system of claim 1, wherein at least one camera is a variable setting camera.

9. The automotive imaging system of claim 8, wherein the at least one variable setting camera comprises the second camera.

10. The automotive imaging system of claim 9, wherein the first and third cameras are fixed setting cameras.

11. The automotive imaging system of claim 8, wherein the processor is further configured for:
sequentially capturing three or more images from the at least one variable setting camera, each image being captured at a different camera setting,
identifying the camera setting corresponding to an optimal image selected from the three or more images, the optimal image having the most amount of objects detected therein, and
setting an operational camera setting for the camera to the identified setting corresponding to the optimal image.

12. The automotive imaging system of claim 11, wherein the camera setting comprises an aperture size.

13. The automotive imaging system of claim 1, wherein the processor comprises field programmable gate arrays.

14. An automotive imaging system comprising:
at least three cameras comprising a first camera, a second camera, and a third camera, the first camera having a first field of view, the second camera having a second field of view, and the third camera having a third field of view, the fields of view being generally directed toward a front portion of a vehicle on which the three cameras are disposed, wherein the first camera is disposed adjacent a left, front portion of the vehicle, the second camera is disposed adjacent a central portion of the front of the vehicle, and the third camera is disposed adjacent a right, front portion of the vehicle, and wherein the second field of view overlaps a portion of each of the first field of view and the third field of view, and a portion of the first field of view overlaps a portion of the third field of view; and
an electronic control unit (ECU) in electronic communication with the cameras, the ECU comprising a processor and a memory, and the processor being configured for:
receiving images captured in the first, second, and third fields of view by the cameras; and
blending the images together to generate a single panoramic image.

15. The automotive imaging system of claim 14, wherein the processor is further configured for communicating the blended image to safety and advanced driver assistance systems of the vehicle.

16. The automotive imaging system of claim 14, wherein the processor is further configured for storing the blended image in the memory.

17. The automotive imaging system of claim 14, wherein each of the first, second, and third fields of view is between about 40° and about 60°, and a total field of view of the blended single image is about 120° to about 180°.

18. The automotive imaging system of claim 17, wherein the first camera is disposed on a windshield adjacent a left A-pillar of the vehicle, the second camera is disposed on the windshield adjacent a rear view mirror of the vehicle, and the third camera is disposed on the windshield adjacent a right A-pillar of the vehicle.

19. The automotive imaging system of claim 18, wherein the second camera is spaced apart from the first camera and the third camera by about 35 to about 60 centimeters.

20. The automotive imaging system of claim 19, wherein the processor is further configured for generating a first stereoscopic image from the images captured by the first and second cameras, a second stereoscopic image from the images captured by the second and third cameras, and a third stereoscopic image from the images captured by the first and third cameras, wherein the first, second, and third stereoscopic images are the images blended to generate a single, panoramic image.

21. The automotive imaging system of claim 14, wherein at least one camera is a variable setting camera.

22. The automotive imaging system of claim 21, wherein the at least one variable setting camera comprises the second camera.

23. The automotive imaging system of claim 22, wherein the first and third cameras are fixed setting cameras.
sequentially capturing three or more images from the at least one variable setting camera, each image being captured at a different camera setting,
identifying the camera setting corresponding to an optimal image selected from the three or more images, and
setting an operational camera setting for the camera to the identified setting corresponding to the optimal image.

24. The automotive imaging system of claim 23, wherein the camera setting comprises an aperture size.

25. The automotive imaging system of claim 14, wherein the processor comprises field programmable gate arrays.

26. The automotive imaging system of claim 14, wherein the processor is further configured for blending images from two of the three cameras to create the single panoramic image in response to a third of the three cameras failing during the vehicle operation.
